(19) United States
(12) Patent Application Publication
(10) Pub. No.: US 2009/0101673 A1
(43) Pub. Date: Apr. 23, 2009

(54) MOTORIZED EXTRUSION TOOL

(76) Inventors: George S. Alioto, Commerce Township, MI (US); Kyung Rok Cho, Yeosu City Junlanamdo (KR)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 11/874,047

(22) Filed: Oct. 17, 2007

(51) Int. Cl. B65D 5/66; G01F 11/00; B65D 88/54

(52) U.S. Cl. 222/113; 222/333; 222/390

(57) ABSTRACT

A fluid extruding device is provided. In one embodiment, the fluid extruding device has a cartridge receiving aperture configured to receive a fluid cartridge with first and second cylindrical chambers. The fluid extruding device further includes an activation mechanism, a motor having a shaft, wherein the motor is configured to selectively rotate the shaft either a clockwise or counterclockwise direction, and an elongated screw connected to the shaft of the motor. In one embodiment, a movable body engages the elongated screw, and is connected to a first piston and a second piston. The first piston has a first pushing plate configured to engage a back of the first cylindrical chamber of the fluid cartridge and the second piston has a second pushing plate configured to engage a back of the second cylindrical chamber of the fluid cartridge.

### FIELD OF INVENTION

The present application relates to a device for extruding fluid. More particularly, the present application relates to a handheld motorized device for extruding fluid from a cartridge.

### BACKGROUND

Fluid extruding devices are known in the art. For example, caulking guns are used for dispensing caulk packaged in a cylindrical container or cartridge. Other handheld devices are used for dispensing glue, epoxy, dental material, or other fluids from cylindrical containers or cartridges.

In dental applications, high viscosity fluids are dispensed into dental molds to make a model of a patient's teeth. The high viscosity fluids may be extruded from cylindrical cartridges having two or more storage chambers for storing different fluids. Manual or pneumatically controlled devices having pistons or pushing pads are known for extruding the fluid from the storage chambers, into a mixing chamber, and out of a nozzle. Due to the high viscosity of the dental fluid, relatively large forces may be required.

U.S. Pat. No. 6,540,113 discloses a handheld fluid dispensing device having an electric motor and a rack-and-pinion design. A pair of racks are arranged substantially perpendicular to the motor, and a series of gears are used to engage the racks and translate them in a forward direction. A coil spring is wound as the racks move forward, placing it under tension, so that when the gears are disengaged from the racks, the spring unwinds and forces the racks back to their original position.

### BRIEF DESCRIPTION OF THE DRAWINGS

In the accompanying drawings, structures are illustrated that, together with the detailed description provided below, describe exemplary embodiments of the claimed invention.

In the drawings and description that follows, like elements are identified with the same reference numerals. The drawings are not to scale and the proportion of certain elements may be exaggerated for the purpose of illustration.

FIG. 1 is a perspective view of one embodiment of an extrusion tool engaging an exemplary fluid cartridge F;

FIG. 2A is a perspective view of an alternative exemplary fluid cartridge F;

FIG. 2B is a rear view of the fluid cartridge F;

FIG. 3 is a side cross-section of one embodiment of an extrusion tool in a first position; and

FIG. 4 is a side cross-section of one embodiment of an extrusion tool in a second position.

### DETAILED DESCRIPTION

The following includes definitions of selected terms employed herein. The definitions include various examples and/or forms of components that fall within the scope of a term. The examples are not intended to be limiting. Both singular and plural forms of terms may be within the definitions.

“Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmed logic device, memory device containing instructions, or the like. Logic may also be fully embodied as software.

“Signal”, as used herein, includes but is not limited to one or more electrical or optical signals, analog or digital signals, one or more computer or processor instructions, messages, a bit or bit stream, or other means that can be received, transmitted, and/or detected.

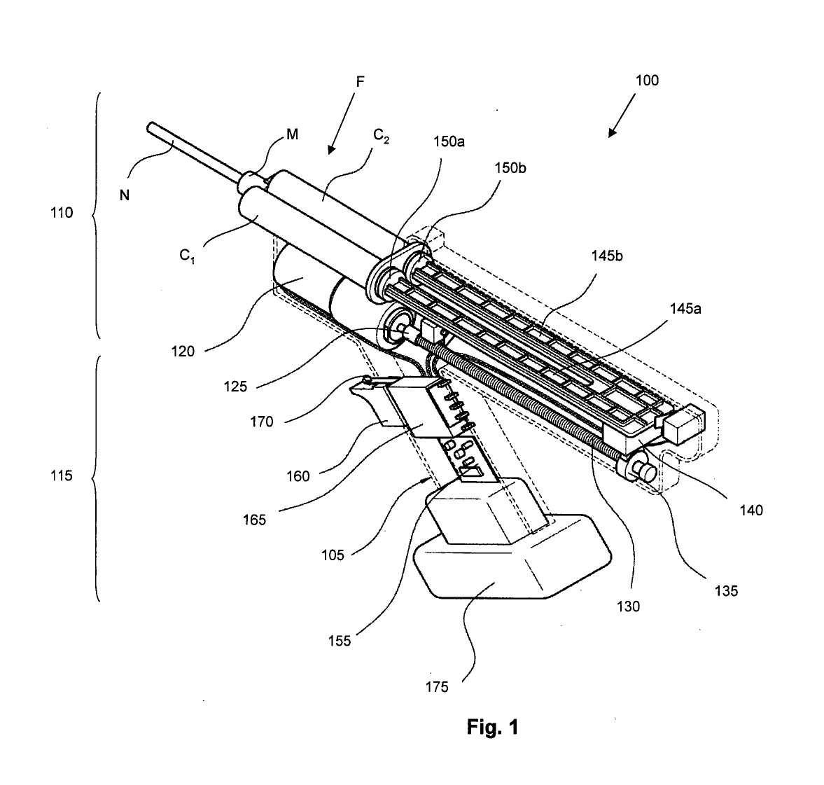

FIG. 1 illustrates a perspective view of one embodiment of an extrusion tool 100 engaging an exemplary fluid cartridge F. In one embodiment, the fluid cartridge F contains dental fluid and the extrusion tool 100 may be used to extrude the dental fluid into a mold for making a dental model. In other embodiments, the fluid cartridge F contains epoxy, caulk, other adhesives, or other fluids.

In the illustrated embodiment, the extrusion tool 100 has a housing 105 defining a main body portion 110 and a handle portion 115. The main body portion 110 houses a motor 120 having a shaft 125 connected to an elongated screw or threaded rod 130. In the illustrated embodiment, the motor 120 is an electric servo motor. In one embodiment, the motor 120 is reversible, such that it may rotate in either a clockwise or a counterclockwise direction. In an alternative embodiment, the motor 120 may be any type of electric motor.

In the illustrated embodiment, the shaft 125 of the motor is coaxial with the threaded rod 130 and the end of the rod is fixed in place by a bushing 135. In this embodiment, the threaded rod 130 rotates at the same speed as the shaft. In an alternative embodiment (not shown), one or more gears may be employed to control the rotational speed and torque of the threaded rod 130 as desired. In one such an embodiment, the axis of the threaded rod 130 is parallel to the axis of the shaft 125. In an alternative embodiment (not shown), the axis of the threaded rod 130 is disposed at an angle with respect to the axis of the shaft 125.

With continued reference to FIG. 1, the main body portion 110 of the housing 105 also houses a movable body 140. The movable body 140 has a threaded aperture that engages the threaded rod 130, such that as the threaded rod 130 rotates, the movable body 140 is translated in a linear direction along the threaded rod 130. In one embodiment, the pitches of the threaded rod 130 and the threaded aperture of the movable body 140 are such that when the threaded rod 130 is rotated in a clockwise direction, the movable body 140 translates in a forward direction and when the threaded rod 130 is rotated in a counterclockwise direction, the movable body 140 translates in a rearward direction. Alternatively, the pitches of the threaded rod 130 and the corresponding threaded aperture of the movable body 140 may be such that when the threaded rod 130 is rotated in a clockwise direction, the movable body 140 translates in a rearward direction and when the threaded rod 130 is rotated in a counterclockwise direction, the movable body 140 translates in a forward direction. In the illustrated embodiment, the movable body 140 is positioned above the threaded rod 130. In alternative embodiments (not shown), the movable body 140 may be positioned below or on either side of the threaded rod 130.

In the illustrated embodiment, the movable body 140 is connected to a pair of pistons, including a first piston having a first shaft 145a and a first pushing plate 150a, and a second piston having a second shaft 145b and a second pushing plate 150b. In FIG. 1, the first and second shafts 145a,b are shown as connected shafts, each having a pair of elongated rods joined by a plurality of links, forming a ladder-like structure. This configuration distributes force along the surface of the pushing plates 150a,b and prevents the pistons from twisting. In an alternative embodiment (not shown), each of the pistons employs a single elongated rod. In another alternative embodiment (not shown), each of the pistons employs three or more rods. It should be understood that the first and second pistons may employ different configurations.

The first and second pistons are configured to engage a first chamber C₁ and a second chamber C₂, respectively, of the fluid cartridge F. In the illustrated embodiment, the fluid cartridge F is an exemplary fluid cartridge known in the prior art. The first chamber C₁ may hold a first fluid and the second chamber C₂ may hold a second fluid. The backs of the chambers are not fixedly attached to the fluid cartridge F, but are configured to move when pressure is applied. Therefore, when the first and second shafts 145a,b and the attached first and second pushing plates 150a,b apply pressure to the backs of the first and second chambers C_{1,2} the fluids are extruded from the first and second chambers C_{1,2} and are mixed in a mixing chamber M and subsequently expelled from a nozzle N.

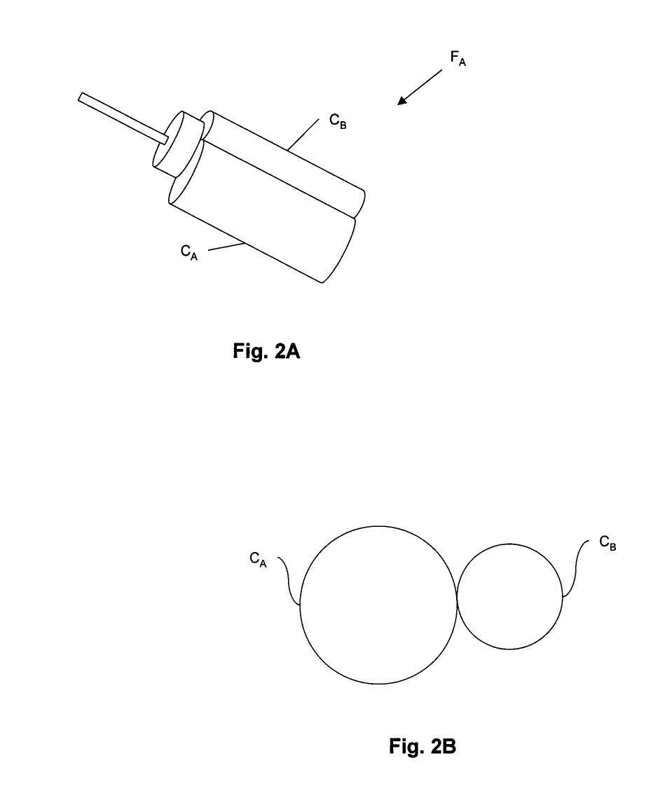

In the illustrated embodiment, the first and second chambers C_{1,2} have the same length and the same diameter. FIGS. 2A and 2B illustrate a perspective and a rear view, respectively, of an alternative embodiment of a fluid cartridge F_{A}. In the illustrated embodiments, the fluid cartridge F_{A} has a first chamber C_{A} and a second chamber C_{B} with the same length, but the first chamber C_{A} has a larger diameter than the second chamber C_{B}. As can be seen in FIG. 2B, the diameter of the first chamber C_{A} may be larger than the diameter of the second chamber C_{B} by a ratio of about 1.5:1. In other known embodiments, the ratio of the diameter of the first chamber C_{A} to the diameter of the second chamber C_{B} may be between about 1:1 to about 5:1.

Returning now to FIG. 1, the extrusion tool 100 is configured to accommodate cartridges of various sizes. In the illustrated embodiment, the first and second pistons include first and second pushing plates 150a,b of equal diameters. In this embodiment, the extrusion tool 100 may accommodate cartridges having chambers with diameters equal to or greater than the diameter of the first and second pushing plates 150a,b. It should be understood that the pushing plates 1501a,b need not engage the entire back of each chamber of a fluid cartridge. In one embodiment, the extrusion tool 100 may accommodate cartridges having chambers with diameters up to five times the diameters of the pushing plates 150a,b.

In an alternative embodiment (not shown), the first pushing plate 150a has a larger diameter than the second pushing plate 150b. The ratio of the diameter of the first pushing plate 150a to the diameter of the second pushing plate 150b may be between about 1:1 to about 5:1. In another alternative embodiment (not shown), the first and second pistons include removable first and second pushing plates 150a,b. In this embodiment, the first pushing plate 150a and/or the second pushing plate 150b may be removed and replaced with pushing plates of a larger or smaller diameter to correspond to diameters of the chambers of various cartridges. The first and second pushing plate 150a,b may be connected to the first and second shafts 145a,b, respectively, by a threaded connection, a press fit connection, a snap connection, or any other known releasable connection.

With continued reference to FIG. 1, the handle portion 115 houses logic 155 configured to control the operation of the extrusion tool 100 and an activation mechanism in data communication with the logic 155. In the illustrated embodiment, the activation mechanism is a trigger 160 in communication with a sensor 165. The sensor 165 may be a mechanical, electrical, piezo-electric, optical, or electromechanical sensor. In this configuration, when the trigger 160 is pressed by a user, the sensor 165 detects the movement of the trigger 160 and sends a signal to the logic 155, which in turn activates the motor 120. In alternative embodiments (not shown), other known activation mechanisms, such as buttons, keys, dials, or toggle switches may be employed.

In the illustrated embodiment, the activation mechanism also functions as a speed control mechanism. In this embodiment, the sensor 165 detects the distance that the trigger 160 is depressed, and sends a signal to the logic 155. When the trigger 160 is depressed a small amount, the logic 155 signals the motor 120 to operate at a low speed. As the trigger 160 is depressed further, the logic 155 signals the motor 120 to increase the speed. In alternative embodiments (not shown), the extrusion tool 100 may employ a separate speed control mechanism, such as a dial, or one or more keys, buttons, or switches. In another alternative embodiment (not shown), the extrusion tool 100 may employ a torque control device to control the amount of torque produced by the motor 120.

In one application, the extrusion tool 100 may be used to extrude fluid from the fluid cartridge F at a constant rate. This would allow the user to apply the fluid evenly to a surface. This may be desirable in some applications. For example, in dental applications, it may be desired to apply the dental fluid evenly to a mold for taking an impression of a patient's teeth. Similarly, it may be desired to apply caulk, epoxy, other adhesives, or other fluids evenly to a surface. However, it will be appreciated that an even application of a fluid may not always desired, and a speed control may aid a user in applying a desired amount of fluid to a surface.

With continued reference to FIG. 1, the extrusion tool 100 may also include a direction control. In the illustrated embodiment the direction control is a toggle switch 170 in communication with the sensor 165. When the toggle switch 170 is in a first position, the sensor 165 sends a first signal to the logic 155. Upon activation of the activation device, the logic 155 will command the motor 125 to turn in a first direction such that the threaded rod 130 rotates in a first direction and the movable body 140 is translated in a forward direction. When the toggle switch 170 is in a second position, the sensor 165 sends a second signal to the logic 155. Upon activation of the activation device, the logic 155 will command the motor 125 to turn in a second direction such that the threaded rod 130 rotates in a second direction and the movable body 140 is translated in a rearward direction.

In alternative embodiments (not shown), the direction control may be a button, key, dial, or any other known control. In another alternative embodiment (not shown), the extrusion tool does not employ a direction control, but instead includes a first activation device for activating the extrusion tool in a first direction and a second activation device for activating the extrusion tool in a second direction. In yet another alternative embodiment (not shown), the extrusion tool 100 does not employ a direction control, and the extrusion tool may only be activated in a first direction. In such an embodiment, the movable body may be manually reversed.

In one embodiment, the direction control includes a safety mechanism that will prevent a user from changing directions while the motor is activated. In an alternative embodiment, the direction may be changed while the motor is operating.

With continued reference to FIG. 1, the handle portion 115 of the extrusion tool 100 further includes a battery 175. In an alternative embodiment (not shown), the battery 175 may be located in the main body portion 110.

In the illustrated embodiment, the battery 175 is a rechargeable battery that is removable from the extrusion tool 100 for recharging and/or replacement. The rechargeable battery may be nickel-cadmium, nickel-metal hydride, lithium, or any other known type of rechargeable battery. In the illustrated embodiment, the rechargeable battery is a customized rechargeable battery configured to fit in the handle portion 115. In alternative embodiments (not shown), the rechargeable battery includes one or more rechargeable AA, AAA, C, D, 9-volt, or any other known type of battery.

In an alternative embodiment (not shown), the battery 175 is a rechargeable battery that is located internally and not removable. In such an embodiment, the entire extrusion tool 100 is placed in a charger or plugged into a power source for recharging. In another alternative embodiment (not shown), the battery 175 is a disposable battery, such as an alkaline, zinc carbon, zinc-chloride, mercury, or other known type of disposable battery. In yet another alternative embodiment (not shown), the extrusion tool 100 does not include a battery, but is instead configured to be connected to an external power source.

In the illustrated embodiment, the internal components of the extrusion tool 100 are arranged such that when the bottom of the handle portion 115 is placed on a flat, substantially horizontal surface (such as a table top) the extrusion tool 100 stands upright in a stable equilibrium position. Further, the arrangement of the internal components in the illustrated embodiment balances the extrusion tool such that when a user holds the extrusion tool 100, the majority of the weight is located in the front of the main body portion 110 and the handle portion 115, making it comfortable for the user to orient the extrusion tool in a downward direction for optimal extrusion of fluids.

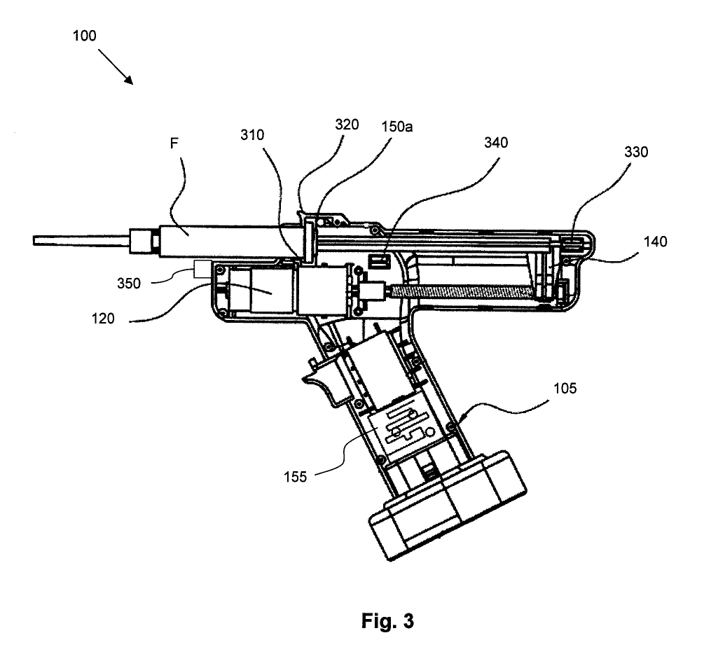

FIG. 3 illustrates a side sectional view of the extrusion tool 100 in a first position with a new fluid cartridge F. In the illustrated embodiment, the movable body 140 is in a rearward position, and the first and second pistons are positioned such that the pushing plates 150a,b are located inside the housing 105, behind a cartridge receiving aperture defined by a protrusion 310 and a pivotal locking mechanism 320. In alternative embodiments (not shown), the extrusion tool 100 may employ a sliding locking mechanism or a removable locking mechanism. In another alternative embodiment (not shown) the extrusion tool does not employ a movable locking mechanism, and the protrusion 310 is shaped to receive the fluid cartridge by a snap fit.

In the illustrated embodiment, a new fluid cartridge F is received in the extrusion tool 100 by positioning the movable body 140 in the rearward position, placing the back end of the fluid cartridge F on the protrusion 310, and closing the pivotal locking mechanism 320 such that it engages the back end of the fluid cartridge F and holds it in place.

With continued reference to FIG. 3, the extrusion tool 100 further includes a rear micro switch 330 in data communication with the logic 155. The rear micro switch 330 is a sensor configured to detect the presence of the movable body 140. The rear micro switch 330 may be a mechanical, optical, electrical, piezo-electric, or electro-mechanical sensor. The micro switch 330 is configured to send a signal to the logic 155 upon detection of the movable body 140. If the motor 120 is operating in a second direction, such that the movable body 140 is moving in a rearward direction, the logic 155 will deactivate the motor. The rear micro switch 330 therefore functions as a deactivation mechanism. Additionally, while the rear micro switch 330 is detecting the movable body 140, the logic 155 will not activate the motor 120 in response to the activation mechanism if the direction control is set for the rearward direction. In this embodiment, when the rear micro switch 330 detects the movable body 140, the logic 155 will only respond to the activation mechanism if the direction control is set for the forward direction.

In the illustrated embodiment, the extrusion tool 100 further includes a front micro switch 340 in data communication with the logic 155. The front micro switch 340 is a sensor configured to detect the presence of the movable body 140. The front micro switch 340 may be a mechanical, optical, electrical, piezo-electric, or electromechanical sensor. The micro switch 340 is configured to send a signal to the logic 155 upon detection of the movable body 140. If the motor 120 is operating in a first direction, such that the movable body 140 is moving in a forward direction, the logic 155 will deactivate the motor. The front micro switch 340 therefore functions as a deactivation mechanism. Additionally, while the front micro switch 340 is detecting the movable body 140, the logic 155 will not activate the motor 120 in response to the activation mechanism if the direction control is set for the forward direction. In this embodiment, when the front micro switch 340 detects the movable body 140, the logic 155 will only respond to the activation mechanism if the direction control is set for the rearward direction.

In an alternative embodiment (not shown), the extrusion tool does not include front or rear micro switches.

In the illustrated embodiment the extrusion tool 100 further includes an illumination device 350. Exemplary illumination device include LEDs, incandescent light bulbs, fluorescent light bulbs, and other known light sources.

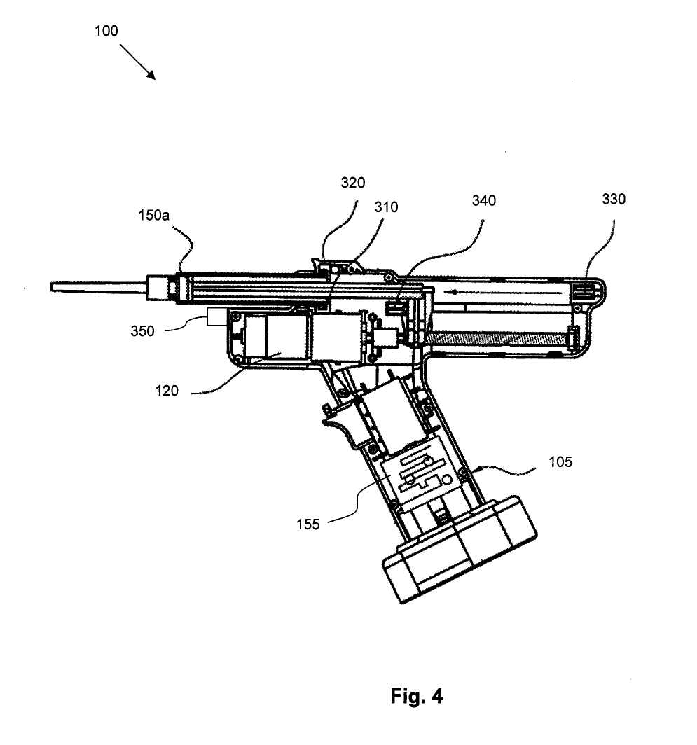

FIG. 4 illustrates a side sectional view of one embodiment of an extrusion tool in a second position. In this position, the pushing plates 150a,b are in the forward-most position. The lengths of the shafts 145a,b are selected such that the pushing plates 150a,b will move the backs of the cartridge F into contact with the front of the chambers C_{1,2}, thereby extruding substantially all of the fluid contained in the chambers C_{1,2}. However, due to the different sizes of commercially available fluid cartridges, the extrusion tool may not extrude substantially all of the fluid from a long cartridge.

A user may remove the fluid cartridge F by first setting the direction control for the second direction and activating the activation mechanism such that the movable body 140 is moved in the rearward direction. When the movable body 140 is in the rear position, the pistons have been fully withdrawn from the fluid cartridge F. The user may then lift the pivotal locking mechanism 320, remove the fluid cartridge F from the extrusion tool 100 and replace it with an unspent cartridge.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general inventive concept.

What is claimed is:

1. A fluid extruding device comprising:
a cartridge receiving aperture configured to receive a fluid cartridge having a first cylindrical chamber with a first diameter and a second cylindrical chamber with a second diameter;
a motor having a shaft, wherein the motor is configured to selectively rotate the shaft in one of a clockwise and a counterclockwise direction;
an activation mechanism configured to activate the motor;
an elongated screw connected to the shaft of the motor;
a movable body engaging the elongated screw, configured to move forward and backward along the elongated screw;
a first piston and a second piston, connected to the movable body such that each of the first and second pistons is substantially parallel to the elongated screw, wherein the first piston has a first pushing plate configured to engage a back of the first cylindrical chamber of the fluid cartridge and the second piston has a second pushing plate configured to engage a back of the second cylindrical chamber of the fluid cartridge; and
at least one deactivation mechanism configured to deactivate the motor.

2. The fluid extruding device of claim 1, further comprising a direction control configured to control the direction of rotation of the motor.

3. The fluid extruding device of claim 1, further comprising an illumination device.

4. The fluid extruding device of claim 1, further comprising a speed control configured to control the rotational speed of the motor.

5. The fluid extruding device of claim 1, wherein the activation mechanism is a trigger configured to control the rotational speed of the motor according to a distance the trigger is displaced.

6. The fluid extruding device of claim 1, wherein the elongated screw is substantially coaxial with the shaft of the motor.

7. The fluid extruding device of claim 1, wherein the elongated screw is substantially parallel with the shaft of the motor.

8. The fluid extruding device of claim 1, wherein the at least one deactivation mechanism includes a first micro switch and a second micro switch, the first micro switch being fixed at a forward position adjacent the elongated screw and configured to deactivate the motor when the movable body reaches the forward position, and the second micro switch being fixed at a rearward position adjacent the elongated screw and configured to deactivate the motor when the movable body reaches the rearward position.

9. The fluid extruding device of claim 1, further comprising a rechargeable battery.

10. The fluid extruding device of claim 1, wherein the first pushing plate has substantially the same dimensions as the second pushing plate.

11. The fluid extruding device of claim 1, wherein the first pushing plate is removably attached to the first piston.

12. A device comprising:
means for receiving a cartridge;
an electric motor;
means for selecting a rotational direction of the electric motor;
means for activating the electric motor;
a threaded rod connected to the electric motor;
a body member having a threaded aperture engaging the threaded rod such that the body member translates along the threaded rod when the threaded rod is rotated;
at least one piston connected to the body member, wherein the at least one piston is configured to engage a cartridge; and
at least two deactivation devices, including a first deactivation device configured to deactivate the electric motor when the body member reaches a first position when traveling in a forward direction, and a second deactivation device configured to deactivate the electric motor when the body member reaches a second position when traveling in a rearward direction.

13. The device of claim 12, further comprising means for adjusting the rotational speed of the electric motor.

14. The device of claim 12, further comprising a battery.

15. The device of claim 12, further comprising a handle.

16. The device of claim 12, further comprising means for providing illumination.

17. A handheld extrusion tool configured to receive a cartridge having a pair of cylindrical chambers, the tool comprising:
a housing having a main body portion and a handle portion, wherein the main body portion is configured to house:
a pair of pistons configured to engage the cylindrical chambers of the cartridge,
a movable body connected to pistons,
an elongated screw engaging the movable body and configured to translate the movable body in a linear direction substantially parallel to the elongated screw,
a motor configured to rotate the elongated screw, and
at least one deactivation mechanism configured to deactivate the motor; and
wherein the handle portion includes an activation mechanism configured to activate the motor.

18. The handheld extrusion tool of claim 17, wherein the at least one deactivation mechanism is configured to deactivate the motor upon the movable body arriving at a predetermined location.

19. The handheld extrusion tool of claim 17, wherein the handle portion is configured to house a rechargeable battery.

20. The handheld extrusion tool of claim 17, wherein the handle portion includes a directional control configured to control the rotational direction of the electric motor.
